(19) United States
(12) Patent Application Publication
(10) Pub. No.: US 2025/0158718 A1
(43) Pub. Date: May 15, 2025

(54) RADIATION SOURCE DRIVER FOR ACCELERATED MODULATION IN AN OPTICAL WIRELESS COMMUNICATION SYSTEM

(71) Applicant: SIGNIFY HOLDING B.V., EINDHOVEN (NL)

(72) Inventor: JOHAN PAUL MARIE GERARD LINNARTZ, EINDHOVEN (NL)

(21) Appl. No.: 18/730,404

(22) PCT Filed: Jan. 17, 2023
(86) PCT No.: PCT/EP2023/050978

§ 371 Date: Jul. 19, 2024

(30) Foreign Application Priority Data
Jan. 21, 2022 (EP) 22152604.9

(51) Int. Cl. H04B 10/524; H04B 10/11

(52) U.S. Cl. CPC H04B 10/524; H04B 10/11

(57) ABSTRACT

This invention relates to a switched-mode light source driver with added functionality for accelerated modulation, which is beneficial for e.g. fast on-off keying (OOK) or pulse amplitude modulation (PAM). An improved output stage includes a low-cost switched-mode power supply in combination with a shunt-switch and a series-switch arrangement, which are used in combination to provide a fast modulator. Thus, two switching functions are used in the output stage, one in series with the light source(s), one in parallel to the light source(s), wherein the light source(s) can be driven between a high and a low output level by using overdriving via a switch mode driver and shorting the output via the parallel switch.

### FIELD OF THE INVENTION

The invention relates to a radiation source driver and driving method for signal transmission in optical communication networks, such as—but not limited to—LiFi networks, for use in various different applications for home, office, retail, hospitality and industry.

### BACKGROUND OF THE INVENTION

International patent application WO2012/085800 A1 discloses devices and methods to control lighting units directly from mains power supply using rectified mains current. To this end it discloses a power factor control and smoothing circuit for controlling current to a solid state lighting load including a capacitor and a current source. The capacitor is connected in a parallel arrangement with the solid state lighting load. The current source in turn is connected in series with the parallel arrangement of the capacitor and the solid state lighting load. The current source is configured to dynamically modulate an amplitude of an input current provided to the parallel arrangement of the capacitor in dependence of the rectified mains voltage.

Optical wireless communication (OWC) systems, such as LiFi networks (named like WiFi networks), enable mobile user devices or Internet-of-Things (IoT) devices (which may be called end points (EP) in the following) like laptops, tablets, smartphones or the like to connect wirelessly to the internet or other networks. WiFi achieves this using radio frequencies, but LiFi achieves this using the light spectrum which can enable unprecedented data transfer speed and bandwidth. Furthermore, it can be used in areas susceptible to electromagnetic interference. An important point to consider is that wireless data is required for more than just our traditional connected devices. Today, televisions, speakers, headphones, printer's, virtual reality (VR) goggles and even refrigerators use wireless data to connect and perform essential communications. With the IoT, the number of devices may grow by multiple orders of magnitude, and include sensors, lighting devices, appliances, etc. Radio frequency (RF) technology like WiFi is running out of spectrum to support this digital revolution and LiFi can help power the next generation of immersive connectivity.

Based on modulations, information in the coded light can be transmitted and detected using any suitable light sensor. This can be a dedicated photocell (point detector), an array of photocells possibly with a lens, reflector, diffuser of phosphor converter, or a camera comprising an array of photocells (pixels) and a lens for forming an image on the array. E.g., the light sensor may be a dedicated photocell included in a dongle which plugs into the end point, or the sensor may be a general purpose (visible or infrared light) camera of the endpoint or an infrared detector initially designed for instance for 3D face recognition. Either way this may enable an application running on the end point to receive data via the light.

As an example, on-off keying (OOK) is an attractive modulation method that is widely used in optical fiber systems and OWC systems based on semiconductor transmitters or emitters (such as laser diodes or light emitting diodes (LEDs). In fact, according to common understanding of communication principles, for a given power budget, the highest throughput can be achieved by a two-level modulation. This understanding is based on an interpretation of communication signals as being points in a multi-dimensional space. The use of multilevel signals demands M=2^{m} signal levels to transfer M bits and all these levels must be separated by some minimum distance to make the signals robust against noise. Hence, it is most energy effective to avoid the use of multiple bits per symbol. However, the use of only two bits per symbol is more demanding in terms of signal bandwidth.

Optical sources, particularly LEDs, are limited in their bandwidth. The parasitic internal capacitance of the junction acts as a low pass filter. Secondly, phosphor used in blue-photon-converting white LEDs is a cause of low-pass behavior. The same applies to detectors, particularly with wide aperture and wide opening angle, as needed in wireless optical communication. Bandwidth limitations can also occur in an optical fiber, particularly in multimode plastic optical fibers (POF). These POFs can be attractive in short haul links, such as inside a home or an apartment, or to connect wireless emitters in an office space of factory hall. In some applications such POFs are even combined with wireless optical links, by wirelessly emitting the signals that also travel over POF, possibly with an electrical or optical amplifier in between. All these effects contribute to the phenomenon that optical channels limit the bandwidth of the modulation signal.

For such limitation bandwidth reasons, todays LED-based LiFi systems often use a form of Orthogonal Frequency Division Multiplexing (OFDM) with multiple bits per symbol, which is more spectrum efficient. However, OOK with only two signal levels is more energy efficient than OFDM. Moreover, OFDM requires highly linear systems with linear power-hungry amplifiers and sophisticated signal processing.

OOK modulation has a further advantage in that the driver can be implemented with a fast on-off switch, which makes it very power efficient and compact. However, the semiconductor transmitter/emitter (e.g., LED, laser) or receiver/detector (e.g., photodiode) may cause a limitation of the available bit rate due to a small opening in the eye diagram at the receiver end, which makes detection more difficult.

Due to the physics of semiconductor light sources (such as LEDs or laser diodes), it takes a certain time to reach a steady-state low or high value of a binary driving signal. Laser diodes are faster but their rise and fall times can still be a limiting factor. If the bit rate is larger than e.g. two times the bandwidth of the semiconductor light source, inter-symbol interference (ISI) occurs.

### SUMMARY OF THE INVENTION

It is an object of the present invention to provide a low-complexity driver and driving method that enable modulating a semiconductor radiation source at a bit rate beyond the 3 dB bandwidth of the radiation source, thus deeply into a region where otherwise (without the use of measures as disclosed here in) severe crosstalk occurs and/or the eye of the eye diagram would be closed, while nonetheless ensuring that the error rate remains sufficiently low.

This object is achieved by a driver circuit as claimed in claim 1, by a transmitter as claimed in claim 13, by a method as claimed in claim 14, and by a computer program product as claimed in claim 15.

According to a first aspect, a driver circuit is provided for driving a semiconductor radiation source in accordance with a digital modulation scheme (e.g., an OOK scheme, a PAM scheme, or another keying scheme) comprising higher and lower states, the driver circuit comprising:
a switched mode power supply for generating an overdrive current supplied to the radiation source, the overdrive current being higher than a steady-state current required for a desired radiation output level for a corresponding state (e.g., the higher state of an OOK modulation scheme or the highest or an intermediate state of a multi-level PAM scheme) of the digital modulation scheme;
a modulator comprising a first switching element connected in series to the radiation source and a second switching element connected in parallel to the series connection of the first switching element and the radiation source; and
a control circuit for controlling the switching states of the first and second switching elements to maintain a radiation output of the radiation source within a target output range for proper detection of the higher and lower states and for closing the second switching element to bypass the overdrive current during an open state of the first switching element.

Thereby, a reduction of the radiation output range can be achieved by not letting the radiation source reach a steady state, but rather by switching the current intentionally to avoid reaching a steady state.

According to a second aspect, a method of driving a semiconductor radiation source in accordance with a digital modulation scheme comprising higher and lower states is provided, the method comprising:
supplying an overdrive current to the radiation source, the overdrive current being higher than a steady-state current required for a desired radiation output level for a corresponding state of the digital modulation scheme;
controlling the switching states of a first switching element connected in series to the radiation source and of a second switching element connected in parallel to the series connection of the first switching element and the radiation source to maintain a radiation output of the radiation source within a target output range for proper detection of the higher and lower states; and
closing the second switching element to bypass the overdrive current during an open state of the first switching element.

Accordingly, the proposed driver/driving concept enables a (low-cost) implementation of a radiation source driver with improved output stage that uses a simple switched-mode power source in combination with a shunt-switch and a series-switch arrangement to provide a fast modulator. Thereby, a pre-compensation for handling limited bandwidth on the transmitter side due to a low-pass filtering effect of the semiconductor radiation source can be enabled. This can be achieved by operating the radiation source driver to drive the semiconductor radiation source with a higher driving current (overdrive current) than would be needed to reach an intended radiation level, but at a limited swing or range of radiation output by lowering the higher limit and/or raising the lower limit of the effectively used radiation output values. The semiconductor radiation source can thus be driven within a maximum and/or minimum (possibly even negative) driving current while its radiation output is modulated within a limited range which is a subrange of the total operating range of the semiconductor radiation source. This allows fast modulation by driving the semiconductor radiation source between selected discrete radiation output levels of the subrange. The subrange can be chosen to be in a steeper slope range of the response of the semiconductor radiation source to a drive pulse, thereby asymmetry in the rising and falling slopes may be reduced. Moreover, a higher current can be used to drive the semiconductor radiation source faster on account of the reduced radiation output range, while the bit duration can be set to be equal to the time it takes to reach an output level adequate to distinguish the logical states in the output signal. When that point is reached the next bit time can start. So, in fact an alternating sequence of binary values (e.g., zeros and ones) determines the achievable bit rate. For other sequences with more than one successive binary value the driving current can be controlled to maintain predefined range-limited radiation output levels. Maintaining the (on or off) driving current might push the radiation output level out of its range, thus hampering the ability of the system to timely reach the target radiation output level that corresponds to an altered symbol (bit) value. The latter corresponds to inter-symbol interference. For instance, during a sustained logical one, the driver can toggle the current in an on/off pattern to ensure that the radiation output level stays near its range-limited value.

Thereby, a property of optical channels which differs from the common situation in radio frequency (RF) systems where the bandwidth of the modulation is often strictly limited to avoid spill-over into adjacent channels can be addressed, thus avoiding steep filters. In intensity-modulated light communication, the problem of spill-over into adjacent wavelengths is often not a dominant design criterion. However, for optical communications, particularly when using LEDs, a relatively gentle roll off above a certain frequency and the bandwidth above the 3 dB attenuation frequency can thus still be exploited for communication. The proposed driver/driving concept allows using modulation frequencies significantly above the 3 dB bandwidth to achieve better throughputs in OWC.

The capacitance of the semiconductor radiation source does not need to be completely discharged as a compromise between achieving a higher transmission quality and being able to reach that the lower output level in a shorter time period. Thereby, the semiconductor light source can be modulated at an increased bit rate beyond a region where severe crosstalk occurs and/or the eye of the eye diagram is closed, while the error rate remains sufficiently low.

It is noted that the proposed driver/driving concept also works well for non-binary sequences with more than two output levels from a larger alphabet than a binary set. The driving current can be controlled to maintain any of the output levels from this alphabet. Through the use of a higher driver current for at least some of the output levels, a faster response can be achieved. If speed is not the primary target, such system may be optimized for power efficiency, rather than for switching speed, the drive current may equal the steady state current for the highest level, assuming that during a relatively long symbol time this steady state is reached with adequate accuracy. In fact for conventional OOK, symbol rates are low enough to ensure that the binary level “1” is reached. The advantage of the solution disclosed will then be achieved for the intermediate levels. These can be created by switching the current in a low-loss manner, thus without the typical losses associated with a linear power amplifier.

It is noted that the proposed driver/driving concept also works well for transmission over optical fibers (e.g. polymer optical fibers (POFs)) which allow small and thus fast detectors and where transmitter limitations are relevant. Thereby, higher bit rates can be achieved for semiconductor radiation sources (e.g. LEDs) over optical fivers as well.

According to a third aspect, a transmitter is provided for generating a radiation signal in an optical communication system, wherein the transmitter comprises an apparatus according to the first aspect.

According to a fourth aspect, a computer program product is provided, which comprises code means for producing the steps of the above method of the second aspect when run on a controller device.

According to a first option of any of the first to fourth aspects, the controlling (e.g., by the control circuit) may be configured to adaptively control the switching states of the first and second switching elements to switch the overdrive current at a timing determined by the target output range between a predetermined upper target level and a predetermined lower target level in response to a control input that indicates the radiation output. Thereby, a feedback signal from the radiation source can be used to control the switching states of the first and second switching elements to maintain the target output range. This provides a simple configuration by using e.g. the voltage across the radiation source as the control input.

According to a second option of any of the first to fourth aspects, which can be combined with the first option, the controlling (e.g., by the control circuit) may be configured to compare the control input with a lower reversal limit and an upper reversal limit and to switch off the overdrive current when the control input has reached the upper reversal limit and/or to switch on the overdrive current when the control input has reached the lower reversal limit. Thus, a simple control loop can be provided to allow an overdrive current while still maintaining the light output within a target range defined by the upper and lower reversal limits.

According to a third option of any of the first to fourth aspects, which can be combined with the first or second option, the controlling (e.g., by the control circuit) may be configured to maintain the predetermined upper target level and the predetermined lower target level by switching the overdrive current at a higher rate than a symbol rate of a data sequence of the digital modulation scheme. In case of a binary data sequence this symbol rate would correspond to a bit rate, whereas in case of a multi-level data sequence, such as a PAM-4 signal, this would correspond to the symbol rate of the multi-level channel symbols (here the PAM-4 symbols). Thereby, the charging and depletion of the internal capacitance of the radiation source can be accelerated to increase the transmission rate of the digital modulation scheme.

According to a fourth option of any of the first to fourth aspects, which can be combined with any one of the first to third options, the transmission quality of the radiation output may be determined based on a feedback information received from a receiving end of the radiation output. Thereby, the channel quality can be considered during the switching process of the modulator to ensure proper detection of transmission states at the receiving end, as a result a smaller radiation output level range/swing may be used when the channel quality as perceived at the receiver side allows, or conversely a larger radiation output level range/swing may be used when required to improve the channel quality as perceived at the receiver side.

According to a fifth option of any of the first to fourth aspects, which can be combined with any one of the first to fourth options, a control input may be provided for setting at least one of a bit rate or duty cycle for the overdrive current, and an allowable maximum and/or minimum output radiation level or output radiation range for the radiation source. Thereby, the driver circuit can be adapted to internal or external fluctuations to thereby maintain a desired transmission quality.

According to a sixth option of any of the first to fourth aspects, which can be combined with any one of the first to fifth options, the switched mode power supply may comprise an inductor to bridge fluctuations of the overdrive current supplied to the radiation source. Thereby, the overdrive current can be stabilized despite short-term load variations.

According to a seventh option of any of the first to fourth aspects, which can be combined with any one of the first to sixth options, an active control loop with a sensing element may be provided to stabilize the overdrive current despite long-term load variations.

According to an eighth option of any of the first to fourth aspects, which can be combined with any one of the first to seventh options, the controlling (e.g., by the control circuit) may be configured to operate the modulator as a tristate modulator with a first state of charging up an internal capacitance of the radiation source, a second state of depleting the internal capacitance of the radiation source, and a third state of holding the charge of the internal capacitance of the radiation source. Thereby, the overdrive current through the radiation source can be switched in an optimized manner with respect to the internal capacitance of the radiation source to improve the transmission rate of the digital modulation scheme.

According to a ninth option of any of the first to fourth aspects, which can be combined with any one of the first to eighth options, a control logic may be provided (e.g., as a part of the control circuit), which is configured to translate a light output monitoring signal (e.g., a light output sensor signal, a voltage across the radiation source, etc.) derived from the radiation source or a detector into a digital signal that indicates a specific level interval within a plurality of reference voltage levels, in which the level of the light output monitoring signal is located. Thereby, more detailed feedback can be provided to optimize the modulator switching process so as to increase the transmission rate of the digital modulation scheme.

According to a tenth option of any of the first to fourth aspects, which can be combined with any one of the first to ninth options, the controlling (e.g., by the control circuit) may be configured to use reference voltage level pairs to provide a hysteresis between which the light output of the radiation source can be maintained during the higher and the lower state, respectively. Thereby, the number of switching operations around the higher and lower states can be reduced to stabilize the switching control process.

According to an eleventh option of any of the first to fourth aspects, which can be combined with any one of the first to tenth options, the switched mode power supply may be configured as a current source, more particularly, a current source with an inductor element and no capacitor element at an output thereof. Thereby, the supplied current can be kept constant during one or several successive symbols in case of any switching operation of the switched mode power supply. On the other hand, in the absence of a capacitor element, the output voltage of the switched mode power supply is allowed to fluctuate rapidly with the modulation rate,

It is noted that the above apparatuses may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the driver circuit of claim 1, the transmitter of claim 13, the method of claim 14, and the computer program product of claim 15 may have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically a block diagram of an optical communication system according to various embodiments;

FIG. 2 shows a flow diagram of driving procedure according to various embodiments;

FIG. 3 shows a flow diagram of a receiver feedback procedure according to various embodiments;

FIG. 4 shows schematically waveform diagrams of light responses for OOK and accelerated OOK;

FIG. 5 shows schematically respective waveform diagrams of a binary data sequence, a light source current and a resulting light output according to various embodiments;

FIG. 6 shows schematically a circuit diagram of a light source driver according to a first embodiment;

FIG. 7 shows schematically a circuit diagram of a light source driver according to a second embodiment;

FIG. 8 shows schematically a basic circuit diagram of a light source driver with shunting modulator;

FIG. 9 shows schematically a circuit diagram of a light source driver according to a third embodiment;

FIG. 10 shows schematically a circuit diagram of a light source driver according to a fourth embodiment;

FIG. 11 shows schematically a circuit diagram of modulation control circuit according to a fifth embodiment; and

FIG. 12 shows a table of a modulation control scheme for a light source driver according to various embodiments.

### DETAILED DESCRIPTION OF EMBODIMENTS

Various embodiments of the present invention are now described based on a light source driver and related control scheme for an optical wireless illumination and communication (LiFi) system. Although the present invention is particularly advantageous within the context of an illumination system, the invention is not limited thereto and may also be used within an optical wireless communication system that is not integrated within an illumination system or within a fiber-based optical communication system or within a wireless communication system that uses radiation in the non-visible range (e.g., infrared (IR) or ultraviolet (UV) range).

Throughout the following, a light source may be understood as a radiation source that generates visible or non-visible light (i.e., including infrared (IR) or ultraviolet (UV)) light sources) for communication purposes. The light source may be included in a luminaire, such as a recessed or surface-mounted incandescent, fluorescent or other electric-discharge luminaires. Luminaires can also be of the non-traditional type, such as fiber optics with the light source at one location and the fiber core or “light pipe” at another. The concepts can also be used in peer-to-peer communication between smartphones or Internet of Things (IoT) devices.

It is further noted that when using optical wireless communication based on invisible parts of the light spectrum, such as infrared and/or or ultraviolet, the system can be fully decoupled from any illumination systems. In such scenarios the optical wireless communications systems may function to primarily provide communication and a separate transceiver node may be used in the optical wireless communication system. Alternatively, such optical wireless communication systems may be complementary to a further function and thus be integrated in other application devices that benefit from such communication functionality; such as personal computers, personal digital assistants, tablet computers, mobile phones, televisions, etc.

Conventional light source luminaires are rapidly being replaced by light emitting diode (LED) or laser-based lighting solutions. In LiFi systems, more advanced LED or laser-based luminaires are enabled to act as LiFi communications hub to add LiFi connectivity to lighting infrastructure. The underlying idea is that an illumination infrastructure is positioned in such a manner that it provides a line of sight from the luminaire to locations where people tend to reside. As a result, the illumination infrastructure is also well positioned to provide optical wireless communication that likewise requires line of sight.

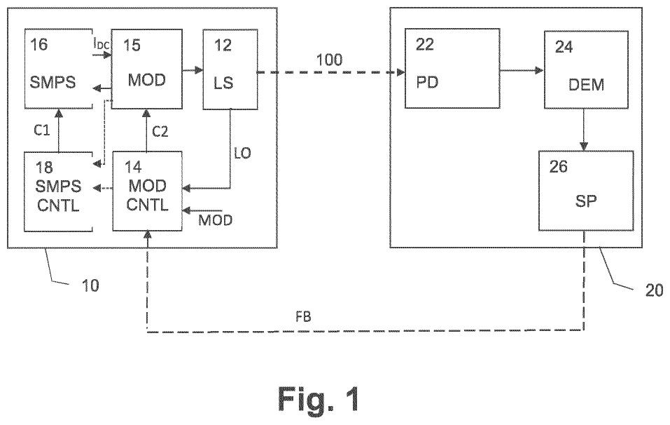

FIG. 1 shows schematically a block diagram of an optical communication system according to various embodiments.

It is noted that—throughout the present disclosure—only those structural elements and functions are shown, which are useful to understand the embodiments. Other structural elements and functions are omitted for brevity reasons.

The optical communication system of FIG. 1 may correspond to a communication link of a LiFi network comprises a transmitter (optical emitter) 10 (e.g., an access point (AP) with a luminaire of a lighting system) connected via an optical channel (e.g., an optical free-space link) to a receiver (light detector) 20. A respective light output 100 (e.g., light beam) generated by a light source (LS) 12 of the transmitter 10 is received by a photo detector (PD) 22 of the receiver 20. The light source 12 may comprise a radiation emitting element (e.g., LED or laser diode) and the photo detector 22 may comprise a radiation detecting element. The waveform of the light output 100 may be chosen to match with response constraints of the transmitter 10, e.g., by containing multiple output levels, as explained later.

Additionally, the transmitter 10 comprises a switched-mode power source (SMPS) 16 (sometimes also called switching-mode power supply, switch-mode power supply, switched power supply, or switcher) that may be configured to provide a high impedance output to generate a stable DC current IDC (rather than a low impedance stable voltage output) which is supplied to a modulator (MOD) 15 which drives the light source 12.

The SMPS 16 is an electronic power supply that incorporates a switching control circuit to convert electrical power efficiently. Like other power supplies, the SMPS 16 transfers power from a DC or AC source (e.g., mains power) while converting voltage and current characteristics. The switching control circuit comprises a pass transistor (supply switching transistor) that continually switches between low-dissipation, full-on and full-off states, and spends very little time in the high dissipation transitions, which minimizes wasted energy. Output regulation can be achieved by varying the ratio of on-to-off time (also known as duty cycle) or the switching rate e.g. based on control information received from the modulator 15 or from an SMPS control circuit or logic (SMPS CNTL) 18 that controls the SMPS 16 (e.g., duty cycle or switching function control) by at least one supply control output (C1) that may be generated based on input information received from the modulator control circuit 14 or the modulator 15.

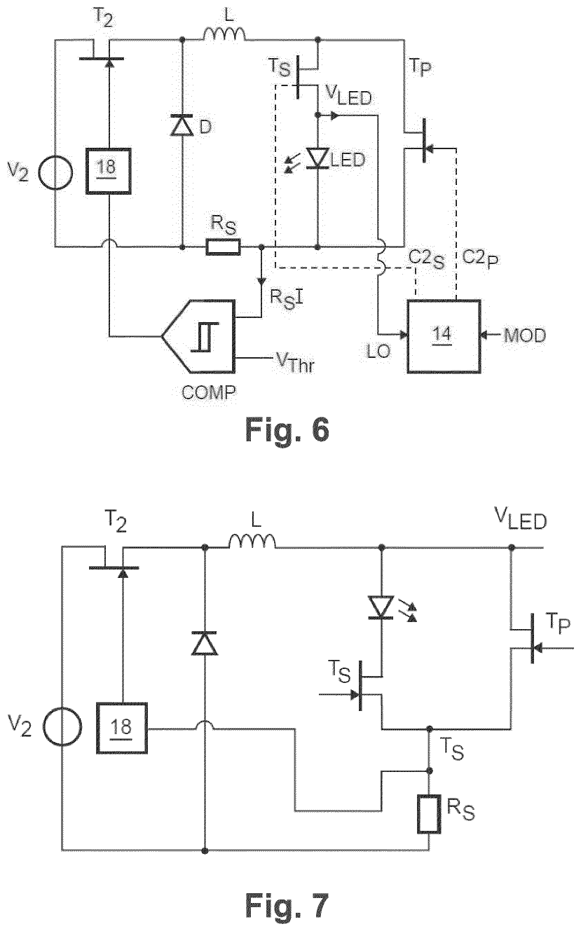

As a short-term measure to ensure high impedance stable-current output of the SMPS 16, an inductor (not shown in FIG. 1) may be provided at the output of the SMPS 16, e.g., to bridge modulation fluctuations supplied to the light source 12. As the modulator 15 is designed to operate at high speed with low-impedance components (such as an LED as the light source 12 with low dynamic resistance), parasitic (wiring) effects may have to be minimized, e.g., by mounting serial and parallel switches (e.g., T_{P} and T_{S} of FIGS. 6 to 10) as close as possible to the light source 12.

Furthermore, as the switching control may be designed to allow fast modulation while keeping the supplied current (but not the voltage delivered by the SMPS 16) constant, the value of any output inductor of the SMPS 16 may be designed to be large enough to keep constant the supplied current during one or several successive symbols, despite any switching of the SMPS 16. On the other hand, the output voltage of the SMPS 16 may fluctuate rapidly, with the modulation rate. Thus, (parasitic) capacitances at the output of the SMPS 16 could be minimized.

Furthermore, as a long-term measure to stabilize the output current IDC if the number of binary states (e.g., 0s and 1s) of digital information conveyed via the light output 100 is unbalanced for a prolonged period of time, line coding or an active control loop with sensing element (e.g., transistor or resistor) may be provided at the SMPS 16.

As explained later in more detail, the modulator 15 may be configured to use “overdrive” currents that are shortened in time duration and do not necessarily coincide with symbol interval transitions of the digital information conveyed via the light output 100.

Moreover, the modulator 15 may be configured to use a shunt switching element (e.g., transistor or other semiconductor switching element) for shunting (by-passing) the light source 12 and/or the supplied output current IDC of the SMPS 16.

In an example, the modulator 15 may be operated as a tristate modulator with a first state of charging up an internal capacitance of the light source 12, a second state of depleting the internal capacitance of the light source 12 (fast sweep out), and a third state of holding the charge of the internal capacitance (except for a leakage via photon generation).

The modulator 15 is controlled by at least one modulator control output (C2) of a modulator control circuit or logic (MOD CNTL) 14 based on a first control input (MOD) for the modulation symbols and a second control input (LO) for a monitoring signal that is indicative of the output level (or the charge level) of the light source 12.

As the SMPS 16 may be configured to drive a fixed current into the modulator 15, special precautions may have to be taken to prevent that during short switching transients it may accidentally happen that switching elements (e.g., neither Tp nor Tc of FIGS. 6 to 10 below) of the modulator 15 do not conduct properly. In such case, the output voltage of the SMPS 16 may rapidly rise, which could damage circuitry of the modulator 15 or the SMPS 16. Precautions may be taken such as configuring the modulation control circuit 14 to ensure proper timing of the switching process (e.g., such that in FIGS. 6 to 10 below Tp is switched on before Ts is switched off).

As explained in the following, the transmitter 10 may be configured to ensure that after the light output 100 reaches a target light level it stays at (or near) that level for the further duration of a corresponding symbol of the digital information conveyed via the light output 100.

The proposed optical communication system of FIG. 1 allows an adaptive or accelerated on-off keying (OOK) scheme to accelerate the transmission rate while keeping the driver or driving circuit (i.e., SMPS 16 and modulator 15) simple and power-efficient. It may however also be used in connection with regular fast-switching OOK, pulse amplitude modulation (PAM) or other digital modulation schemes.

A binary data sequence is supplied to the modulation control circuit 14 as the first control input (MOD) to control the modulator 15 to generate a driving signal (e.g., driving current) in accordance with an enhanced driving scheme and supply it to the light source 12 to generate the light output 100 with accelerated OOK or other keying-based modulation scheme. More specifically, the modulator control circuit 14 may be configured to determine at least one of a switching time or rate (e.g. bit rate) for the driving signal and an allowable maximum and minimum light output level or output light range for the light source 12 based on e.g. a transmission quality information (FB) fed back from the receiver 20. E.g., when the transmission quality increases, the driving signal and thus the drive current can be switched at a higher rate (increased bit rate) to reduce the distance between the maximum and minimum light output level or the allowable maximum and minimum light output levels are set to be closer together so that the drive signal is switched at a higher rate.

Moreover, the second control input (LO) that indicates the light output level or a property or parameter related to light level to the modulator circuit 14 may be used by the modulator control circuit 14 to control the driving signal outputted by of the modulator 15. Based on the first and/or second control input, the modulator 15 adjusts the range and/or level of the driving current of the light source 12 (and thus the light output 100) in accordance with the proposed accelerated keying-based modulation scheme (e.g., accelerated OOK). In an example, the modulator 15 (i.e., modulator driver) may act as a switching device that is controlled by the modulator control output (C2) to switch the driving current through the light source 12 between a number of discrete values (e.g. 2 or 4 discrete vales).

At the receiver 20, the output signal of the photo detector 22 may be supplied to a demodulator circuit (DEM) 24 where it is demodulated by detecting or discriminating light output levels to obtain a binary data sequence. This binary data sequency may then be decoded in signal processor (SP) 26, e.g., a digital signal processor (DSP), to obtain output data which should correspond to the original input data (i.e., original binary data sequence of the first control input (MOD)) supplied the transmitter 10. Then, an error detection function of the signal processor 26 may check the output data based on an error detection scheme (e.g., parity checking, cyclic redundancy check (CRC), error correction coding etc.) to determine a transmission quality (e.g., signal-to-noise ratio) of the optical transmission. The checking result may optionally be fed back as transmission quality information from the receiver 20 to the transmitter 10 via an optical or other wireless channel.

In an example, a control software may be running on a central processing unit (CPU) provided in the SMPS and/or modulator control circuits 18, 14 and/or the signal processor 26 of the receiver 20 to provide the controller and receiver functions discussed herein.

Moreover, it is noted that the transmitter 10 may be part of a transceiver circuit of a network device, that comprises a photo detector and reception circuitry similar to the receiver 20 for bidirectional communication.

Being a semiconductor device (e.g., LED or laser), the physical properties of the light source 12 modify the optical output 100 to become a low pass filtered version of the driving current. More specifically, a junction of a semiconductor light source is a capacitance and discharging of that capacitance by means of hole-electron pairs that recombine into photons is a nonlinear function of the charge. Particularly, when the capacitance is in a state of low charge, not many photons are created such that discharging gets slower and slower. If the symbol rate of the driving signal is faster than the 3 dB bandwidth of the light source 12, then ISI would occur without further measures. However, the switching time/rate (e.g., bit rate) of the light source 12, which corresponds to the time resolution of on-off switching, can be controlled by the modulator control circuit 14 to be faster than the symbol rate or to occur at other (later or earlier) instances than the bit transition of the digital information conveyed via the light output 100. As a result, it can be facilitated that the light output reaches the light level target value at the sampling instant.

According to various embodiments, an on-state of the driving current for switching on the light source 12 is made intentionally larger than the driving current that leads to a desired steady state light output. Additionally, an off-state of the driving current for switching off the light source 12 may not be a zero current (i.e., a disconnection of the driving current from the current source).

In an example, during the off-state of the driving current, the light source 12 may be short-circuited to achieve faster discharging the light source 12. Thereby, a “higher-than-needed” on-current and a “short-circuited” light source 12 during an off period can be combined to achieve an accelerated OOK.

In another example, an intentional negative driving current may be applied as off-current during an off period of the light source (“active sweep out”). This could be achieved e.g. by a transistor with a source-drain or collector-emitter connection across the light source. Such sweep-out current can be applied to faster reach the light output level that corresponds to a logical zero. However, for multiple successive zeros, it may not be attractive to fully deplete the junction (internal capacitance) of the light source 12. In such case, the recovery to a charged state (e.g., needed to transmit a logical “1”) would be excessively long. Thus, measures are taken to ensure that, after a rapid sweep-out during a first “0”, the junction of the light source 12 stays lightly charged during following “0”s. This can be achieved by injecting short bursts of on-currents.

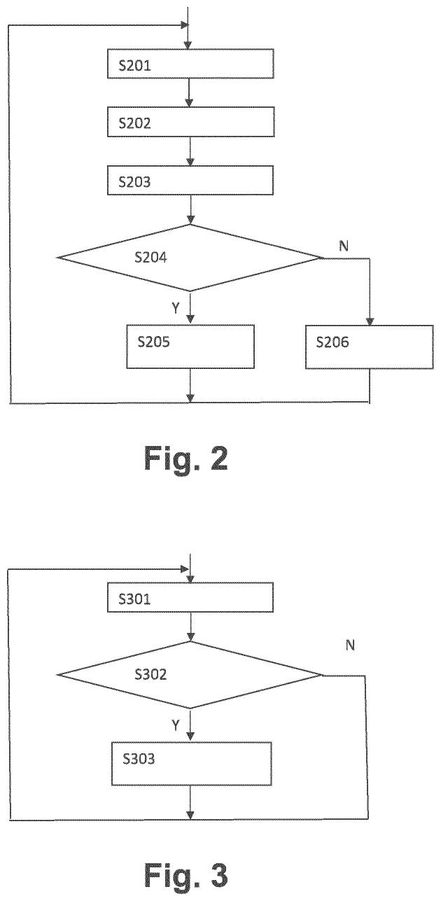

FIG. 2 shows a flow diagram of driving procedure according to various embodiments which may be implemented by the SMPS and modulator control circuits 18, 14 of FIG. 1.

In a first step S201, transmission quality (e.g., quality of service (QoS), signal-to-noise ratio (SNR), bit error rate (BER), symbol error rate (SER) etc.) of the optical channel is determined, e.g., based on transmitter-side measurements or feedback information from the receiver side). Then, in step S202, a bit rate and/or a range of light output levels (or maximum and/or minimum light output levels) for driving the transmitter light source are determined (e.g., stepwise increased or decreased) based on the determined transmission properties and used for modulating the transmitter light source.

In step S203, the current binary data sequence or pattern to be used for modulating the transmitter light source is monitored. If it is it is determined in subsequent step S204 that the monitored data sequence includes multiple successive levels of same binary value (e.g. a sequency of two or more “0”-values or a sequency of two or more “1”-values), then the procedure continues with step S205 where the modulation or switching bit rate for the transmitter light source is increased by a predetermined amount and a predetermined sub-bit pattern is incorporated during the multiple successive levels of same binary value) to keep the light output level at the determined maximum or minimum light output. Otherwise, if no multiple successive levels of same binary values if included in the current binary data sequency or pattern, the procedure branches to step S206 where the transmitter light source is driven with predetermined bit rate determined in step S202.

Finally, the procedure jumps back to the initial step S201 and continues so long as data is available for transmission.

In a practical system, steps S203 to S206 may run at very high speed (e.g. hundreds of Megabits per second) and may therefore be implemented in hardware. The adaptation of the bit rate in steps S201 and S202 can be done slowly (e.g., at speeds around one or a few seconds) and in response to changes in the channel (for instance by motion of the client device(s)). Moreover, such bit rate adaptation may require protocol overhead to align the transmitter side and receiver side which may be in (embedded) software and may be done every few (hundreds) of milliseconds. Hence, the level switching loop and the adaptive bit rate control may be separated in different processing flows.

In another embodiment, in the procedure of FIG. 2 may be refined to implement a tristate driver with a first state during which a first current (e.g., positive current) is supplied to pull up the charge in the transmitter light source 12, a second state during which a second current (e.g., negative current) is supplied to sweep-out the charge from the transmitter light source 12, and a third (idle) state during which no current flows. The idle state can facilitate the emission of multiple successive logical zeros (or logical ones), during which the junction of the transmitter light source 12 tends to slowly discharge due to (photonic and non-radiative) hole-electron recombination, such that only a short burst of a positive current may be needed during sub-bit intervals. Rapid alternating of such positive current bursts with a negative current may cause excessive waste of energy while alternating with a positive current and an idle state is more energy efficient. Thus, such a tri-state operation may involve a high positive current used to pull up the charge in the transmitter light source 12 during transitions to a higher light output level. Negative sweep-out currents may be used to accelerate the transitions to lower light output levels. The idle (zero current) mode may be used when no small changes in light output level are expected. The idle state may be alternated with a short positive burst to (re-)charge the junction of the transmitter light source 12.

FIG. 3 shows a flow diagram of receiver feedback procedure according to various embodiments where the transmission quality information is fed back from the receiver side to the transmitter side.

In step S301, the received data sequence (e.g., after decoding or demodulating) is evaluated to determine transmission quality (e.g., signal-to-noise ratio (SNR), bit error rate (BER), symbol error rate (SER) etc.) of the optical channel. Then, in step S302, it is checked whether a predetermined threshold value of at least one transmission quality parameter (e.g., signal-to-noise ratio (SNR), bit error rate (BER), symbol error rate (SER) etc.) has been exceeded. If so, the procedure continues at step S303 where a request to reduce the bitrate is fed back to the receiver side, e.g., via an optical channel or an RF channel (NFC, Bluetooth, WiFi etc.). Otherwise, if the threshold value is not exceeded, the procedure jumps back to step S301 and continues as long as the transmission is ongoing.

As an alternative, it could be checked in step S302 whether the threshold values is not exceeded and the feedback information signaled in step S303 could be a request to maintain the bit rate, while the request to reduce the bit rate could be signaled otherwise.

Thus, according to various embodiments, the full range of light levels available for OOK or other keying modulation is restricted to a reduced swing or range of the light output level determined by the minimum and/or maximum light output level, such that the light output levels can still be discriminated at the receiver side, although the eye diagram opening is smaller due to the filtering characteristic of the transmitter light source at selected higher bit rates.

Furthermore, in case of 0-to-0 and 1-to-1 bit transitions due to multiple successive levels of same binary values, “sub-bit” on-off switching at an increased “bit” rate (“fiddling”) can be introduced to sustain the light level (rather than to let it sink or rise further). This reduces the ISI. Although this measure may reduce the distance between the maximum and minimum light output levels to some extent, it provides the advantage of increased ISI-free bit rates (i.e., increased transmission speed) when the transmission quality is sufficiently high.

If during a subperiod of a symbol interval on-off switching is needed, there is some degree of freedom in how the on, hold and deplete states are sequenced. In an example, the sequence may be optimized to keep the level as constant as possible during the sample times. This avoids that if a time error occurs, the system may make symbol decision errors. Particularly, for higher-order modulations with more levels than OOK, level transitions and level-hold sequences may have many solutions that all reach the target level during the sampling moment. Sequences that have a steep slope in approaching a subsequent level may lead to errors. In an example, “hold” states (e.g., Ts off in FIGS. 6 to 10) rather than “on” or “deplete” states (e.g., Ts on in FIGS. 6 to 10) may be used near the sampling instants.

In an embodiment, the modulator control circuit 14 may make use of known properties of the low-pass characteristic of the transmitter light source 12 by switching the light source in a such way that at particular sampling moments, the optical output signal reaches one of multiple discrete light output levels (e.g., the determined maximum and minimum light output values in case of a two-level system).

In an example, the modulator control circuit 14 may use a timing advance or timing delay in the switching operation to target the desired light output levels. Within the interval transmitting the symbol (e.g., a logical “0”), the modulator control circuit 14 may insert sub-bit periods or patterns of a different logical value than that of the current symbol (e.g. current-on/off), to achieve a desired light output level of the transmitter light source 12 at a sampling moment.

In another embodiment directed to optimized light output levels, the modulator control circuit 14 may achieve a desired low light output level f0 and a desired high light output level f1 such that the light output levels f0 and f1 can be detected by the receiver as representing a logical level “0” and “1”, respectively, that the light output level f0 for the logical value “0” is strictly positive and higher than a steady state light output level when the driving current is continuously switched to its lowest value, and that the light output level f1 for the logical value “1” is smaller than a steady state light output level that would correspond to a driving current being continuously switched on.

In an example, the selection of the output light f0 and f1 may be optimized such that the rise time from f0 to f1 is equal to the fall time from f1 to f0 (with the off-current starting at f1). E.g., for two successive logical values “0”, the modulator control circuit 14 may ensure that the light output level of the transmitter light source 12 equals f0 at corresponding two successive sample moments t1 and t2, e.g., by applying the on and off-current during fractions (sub-bit periods) of the interval between the sample moments t1 and t2. Similarly, for two successive logical values “1”, the modulator control circuit 14 may ensure that the light output level of the transmitter light source 12 equals f1 at corresponding two successive sample moments t1 and t2, e.g., by applying the on and off-current during fractions (sub-bit periods) of the interval between the sample moments t1 and t2.

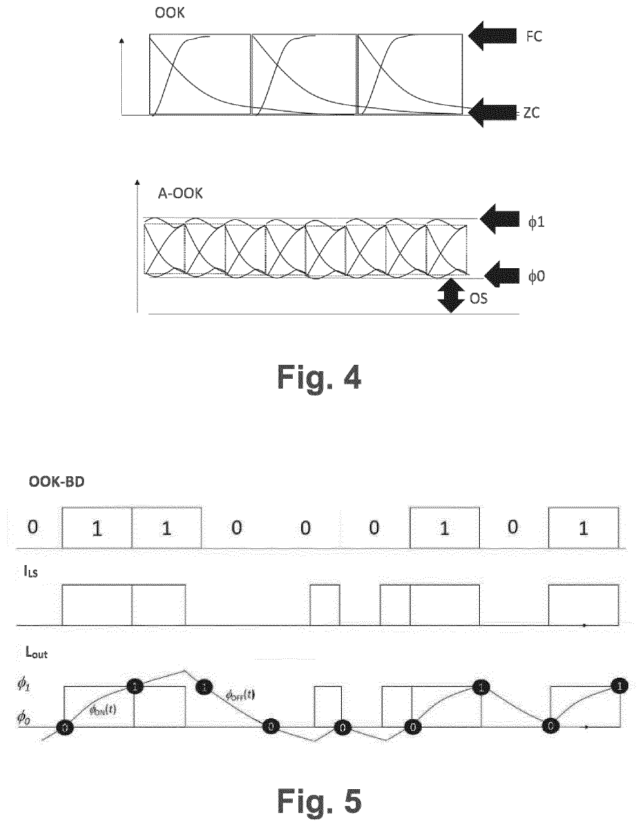

FIG. 4 shows schematically waveform diagrams of the light output 100 (light response) of the transmitter light source 12 as a function of time for normal OOK and accelerated OOK (A-OOK) for different switching speeds according to various embodiments.

In response to switching on and off the driving current supplied to the transmitter light source 12 (e.g., LED), different rise and fall characteristics with different rise and fall times are observed. The upper waveform of FIG. 4 shows a typical OOK waveform at a rate below the bandwidth of the transmitter light source 12, where sufficient time is available for the light source current and thus the light output level to reach the zero state (i.e. zero driving current (ZC) or off-current) and to reach the full light output level when the full driving current (FC) or on-current is applied.

Additionally, the lower waveform of FIG. 4 shows an output light waveform for the proposed A-OOK driving that limits the level swing or range in light output and allows faster modulation. Due to the increased bit rate beyond the bandwidth of the transmitter light source 12, the time available for the light source current and thus the light output level is no longer sufficient to reach the zero light output level and the full light output level, respectively. As a result, the light output varies between a minimum light output level f0 larger than zero and a maximum light output level f1 lower than the maximum level of the OOK waveform (upper diagram of FIG. 4), so that an offset level OS of the light output is obtained. Thus, the A-OOK driving scheme (e.g., switching time/rate, maximum and/or minimum light output level) is controlled based on the transmission quality of the optical channel to allow discrimination of the logical output levels at the receiver at an increased bit rate.

FIG. 5 shows schematically waveform diagrams of a binary data sequence (OOK-BD), a light source current (I_{LS}) and a light output (Lₒᵤₜ) according to various embodiments.

The upper waveform indicates the binary data sequence (OOK-BD) with normal OOK modulation used for driving the transmitter light source, as a function of time.

Furthermore, the middle waveform shows the driving current (I_{LS}) supplied to the transmitter light source 12 after processing by the modulator 15 in accordance with the proposed A-OOK mode, as a function of time.

Finally, the lower waveforms show the light output (Lₒᵤₜ) of the transmitter light source 12 (curvy lines) and the binary driving current as a function of time caused by on-off periods (bit rates) that differ from the typical OOK symbol timings. The symbol value is reached at and indicated in the dark circles. Here, levels f0 and f1 represent the target light output values for binary logical values “0” and “1”, respectively, which are to be reached at sampling instants. However, at any other instance a possible deviation outside the sampling moments is constrained to ensure that the correct light output levels can be reached timely at the sampling moments.

As can be gathered from the middle and lower waveforms of FIG. 5, 1-to-1 transitions of the binary data sequence are modified by shortening the second time period of the on-current to sustain the maximum light output level f1. Additionally, 0-to-0 transitions of the binary data sequence are modified by adding an intermediate on-current of a shortened (i.e., sub-bit) time period to sustain the minimum light output level f0.

The on-off switching of the driving current of the transmitter light source is chosen in the A-OOK driving mode such that a particularly, intentionally selected maximum and/or minimum light output level is reached at the sampling time. In an example, the on-off pattern of the driving current does not necessarily follow the binary pattern of the binary data sequence, particularly not during many successive bits of the same value.

In a first example of the A-OOK driving mode, the intentionally selected maximum and/or minimum light output level can be reached or kept by changing the time instances at which the driving current is switched on or off to a sub-bit timing.

In a second example of the A-OOK driving mode, the intentionally selected maximum and/or minimum light output level can be reached or kept e.g. during a “011” bit sequence by maintaining the current in an on-state after the first binary value “1” for a sub-bit period that is a predetermined fraction of the bit duration, but then switching off the driving current before the transmission interval of the second binary value “1” ends (delaying approach).

In a third example of the A-OOK driving mode, the intentionally selected maximum and/or minimum light output level can be reached or kept e.g. during a “001” bit sequence by switching on the driving current before the start of the transmission interval of the binary value “1” to ensure that the two successive binary values “0” are both received at the same minimum light output level (time-advancing approach).

In a fourth example of the A-OOK driving mode, the intentionally selected maximum and/or minimum light output level can be reached or kept e.g. during runs of multiple successive bits of the same binary value by inserting short on- or off-periods of the driving current, respectively.

In a fifth example of the A-OOK driving mode, the intentionally selected maximum and/or minimum light output level can be reached or kept e.g. during a “000” bit sequence by inserting a short sub-bit on-period of the driving current to maintain the minimum light output level.

In the following, various exemplary circuits for implementing a light source driver with the SMPS 16, the SMPS control circuit 18, modulator 15 and/or the modulator control circuit 14 of FIG. 1 are described with reference to FIG. 6 to 11.

FIG. 6 shows schematically a circuit diagram of a light source driver according to a first embodiment.

An output current of a voltage source V2 is switched by a controlled switching supply transistor T2 (e.g., field-effect transistor (FET)) with a high output resistance (current source) and supplied via an inductor L (for a stable driving current) to a series connection of a serial transistor Ts (e.g., field-effect transistor (FET)) and an LED (i.e., transmitter light source). A further parallel transistor Tp (e.g., field-effect transistor (FET)) is connected as a shunt in parallel to the series connection of the serial transistor Ts and the LED. The current through the series connection and the parallel transistor Tp is routed via a serial current sensing resistor Rs back to the voltage source V2. Furthermore, a diode D is connected between the output terminal (e.g., source electrode) of the switching supply transistor T2 and the reference electrode of the voltage source V2 to prevent sudden switch-offs of the current through the inductor L.

The switching operation (e.g., duty cycle) of the switching supply transistor T2 is controlled by the SMPS control circuit 18 based on a result of a comparison of a preset threshold voltage V_{Thr} with a voltage across the current sensing resistor Rs (i.e., V=RsI) by a hysteresis comparator (COMP). The voltage across the serial resistor indicates the driving current supplied to the LED.

Furthermore, the serial transistor Ts and the parallel transistor Tp are operated as switches controlled by the modulator control circuit 14 via respective modulator control outputs C2s and C2p applied to their control terminals (e.g., gates) and generated based on the received first control input (MOD) and second control input (LO). The second control input (LO) corresponds to a voltage V_{LED} across the LED.

Thereby, the modulation of the LED as the transmitter light source is achieved by switching the driving current through the LED by the serial and parallel transistors Ts, Tp. The inductor L serves as an energy storage of variable energy and thereby stabilizes the driving current of the LED despite short term variations (due to the binary modulation of the driving current). The parallel (shunt) transistor Tp can act as a bypass for shunting the driving current from voltage supply V2 to reference potential (e.g., ground). Together with the serial transistor Ts, a tristate modulator circuit is obtained, by which the internal capacitance of the LED can be charged (by switching on the serial transistor Ts and switching off the parallel transistor TP), discharged/depleted (by switching on the parallel transistor Tp and switching off the serial transistor Ts)), or held (by switching off the serial transistor Ts).

The inductor (e.g., coil) L is dimensioned to properly reduce current variations during one symbol time of the modulation sequence. The driver may be operated based on a symbol clock of the modulation sequence and an operating clock of the SMPS 16 (e.g., an implicit (e.g. self-oscillating) or explicit clock for operating a switching arrangement of the SMPS 16).

In an example, the symbol clock may be much faster than the operating clock of the SMPS 16. Therefore, the inductance of the inductor L must be selected to be large enough to ensure that the supplied current I_{DC} does not exceed a maximum allowable variation range during a predetermined number of symbol time intervals (e.g., a fraction of a millisecond) and resulting maximum gradient dI_{DC}/dtₘₐₓ. Thus, the inductance L can be selected such that L=V/(dI_{DC}/dtₘₐₓ), when the voltage V changes from zero (short) to a desired LED junction voltage (e.g., a few volts). Then, any inductor L designed to keep a reasonably constant current I_{DC} during one switching cycle of the SMPS 16 also ensures sufficiently constant current during a symbol period of the modulation signal.

Moreover, the coil of the inductance L may be designed for a low parasitic capacitance, to avoid resonances with the LED junction capacitance when the modulator 15 switches the LED.

The current sensing resistor Rs provides a feedback loop for the total current through the LED and the shunting parallel transistor Tp to stabilize the current despite long-term load variations.

The proposed tri-state driver of FIG. 6 allows the use of a supply current (driving current) that is larger than the steady-state current needed for conveying a binary state “1” in OOK to thereby increase OOK data rates and allow accelerated OOK, as described above with reference to FIG. 5.

Furthermore, the tristate driver allows use of PAM with a fixed driving current for data transmission. This allows a simple, not complex implementation that is power efficient, as it avoids the use of a linear power amplifier.

The driving current through the inductor L may be short-term peak current into the LED for charging the internal capacitance. To accelerate the rise time to reach the higher binary level “1”, the driving current can be larger than the driving current that corresponds to the steady-state current required for the light level of the higher binary level “1”. That is, the LED is overdriven with a larger current to charge it faster.

The driving current charges up the LED as quickly as possible to reach the higher binary level and is then switched off. Even for multiple higher binary states “1” in a row, the switching supply transistor T2 is conducting for a substantial portion of the time and is open just long enough to charge up the LED. The control terminal (e.g., gate) of the switching supply transistor T2 is controlled by the SMPS control circuit 18 e.g. in a self-oscillating manner or based on a hysteresis by monitoring the current through current sensing resistor R2.

However, the parallel transistor Tp may discharge the LED, which is less desirable when the transmitter is operated in an accelerated OOK mode and a sequence of successive high binary states “1” is to be transmitted. When the charge of the LED (e.g., measured via the voltage VLED) exceeds a desired value, the parallel transistor Tp is closed, which reduces the charge of the LED very quickly such that immediately afterwards the serial transistor Ts must be opened again. This cycle is repeated continuously during the transmission of successive high binary values “1”, which requires very fast transistors with high power consumption unwanted electromagnetic interference (EMI).

It is however useful to have the serial transistor Ts in series with the LED as well, as it avoids that the parallel transistor Tp rapidly discharges the LED when a high binary level is to be maintained. Thus, after a 1-to-0 transition, the parallel transistor Tp is closed and the serial transistor Ts is also closed to discharge the LED as quickly as possible. When the serial transistor Ts is open, the parallel transistor Tp can be closed to avoid any damage to the circuit. In fact, this creates a tri-state modulator.

A fourth state may also be possible, where the parallel transistor Tp (i.e., shunt) and the serial transistor Ts are both open (i.e., none of them is conducting). However, this fourth state would disconnect the inductor L, while a non-zero current is flowing through it. This typically leads to damaging voltage spike. Therefore, measures are to be taken anyway to avoid damage during switch state transitions and/or in failure modes (e.g., if the parallel transistor Tp breaks or fails to protect the LED and VLED may get too large.

FIG. 7 shows schematically a circuit diagram of a light source driver according to a second embodiment.

Similar to the first embodiment, the SMPS circuit works as a buck converter (step-down converter) with optimized control e.g. for A-OOK, i.e., a DC-to-DC power converter which steps down the supply voltage of the voltage source V2 (while drawing less average current) from its input (supply) to its output (load) by the combination of the diode D, the switching supply transistor T2 (while the diode D may be replaced by a second transistor used for synchronous rectification) and the inductor L. The SMPS circuit is called a buck converter because the voltage across the inductor L “bucks” or opposes the supply voltage.

A compact simple modulator can be provided by the two transistors Ts, Tp of the modulator and the inductor L2. The serial transistor Ts controls the modulation of the light output of the LED and the parallel transistor Tp controls the current through the coil of the inductor L. Thus, both a shunt switch (i.e., parallel transistor Tp) and a disconnect switch (i.e., serial transistor Ts) are provided for the LED in addition to the supply switching transistor T2 of the SMPS circuit. That is, three transistors are used in the light source driver with the SMPS circuit and the modulator.

Furthermore, circuit extensions can be provided to make the light source driver better suitable for fast modulation schemes (such as A-OOK) with the purpose of allowing a separation of an active LED discharging function between and a bypass function for the current through the inductor L if the LED does not need to be discharged.

To achieve this, the shunting parallel transistor Tp provides a bypass path for the load current if the serial transistor Ts is open. Thus, the current through the inductor L can be sustained irrespective of whether the LED is discharged or not by providing a bypass of the series connection of the serial transistor Ts and the LED via the current sensing resistor Rs to the reference potential (e.g., ground) of the voltage source V2.

The voltage over the current sensing resistor Rs is then used as an input of the SMPS control circuit 18 for controlling the supply switching transistor T2.

The current through the inductor L (as measured via the current sensing resistor Rs) is controlled to be equal to the on-current of the LED e.g. for non-accelerated conventional OOK. The light source driver circuit can then be used to modulate OOK by setting the current through the inductor L to equal the current through the LED during the higher binary state (e.g., “1”) and controlling the switching of the serial transistor Ts by the modulator control circuit 14 (not shown in FIG. 7) to follow a bit pattern of the first control input (MOD) corresponding to the digital information to be conveyed via the light output of the LED.

Alternatively, the current through the inductor L can be controlled to be larger than the driving current needed by the LED to signal the higher binary state (e.g., “1”), while the serial transistor Ts can be controlled by the modulator control circuit 14 to maintain the light output of the LED stable around its target level.

Although the converter of the light source driver is configured as a buck converter (in which the load voltage usually needs to be lower than the voltage of the voltage source V2, the specific circuit design of the proposed light source driver for fast keying allows a voltage of the voltage source V2 that can either be lower or higher than the on-voltage (junction voltage) of the LED.

If the voltage (source voltage) of the voltage source V2 is lower than the on-voltage of the LED, then the required average voltage of the LED (averaged over the two binary states “0” and “1”) needs to be lower than this source voltage. A start-up period may be implemented, in which both the supply switching transistor T2 and the parallel transistor Tp are closed, to build up a current in the inductor L. This start-up period can be selected to correspond to multiple bit durations of the conveyed digital information.

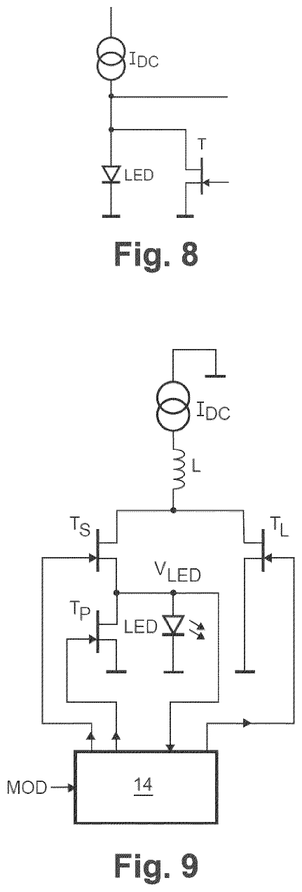

FIG. 8 shows schematically a basic circuit diagram of a light source driver with shunting modulator.

In its basic form, the parallel, shunting modulator consists of a current source with high output impedance for generating a supply current I_{DC} and feeding into an LED (transmitter light source) with a parallel transistor T.

Such a basic modulator has two operational states including an open transistor state during which the full current goes through the LED and a close transistor state during which the LED is shunted.

According to various embodiments and as explained above, it is proposed to accelerate the switching operation of the light source driver by extending the modulator to become a tri-state modulator with a first state during which the full current is fed through the LED, a second state during which the LED is shunted for fast depletion, and a third state during which the LED is disconnected, but the DC current is allowed to pass through a closed bypass transistor.

FIG. 9 shows schematically a circuit diagram of a light source driver according to a third embodiment.

In the third embodiment, a parallel transistor Tp is connected directly in parallel to the LED and the supply switching transistor TL is connected in parallel to the series connection of the serial transistor Ts and the LED.

The control terminals (e.g., gates) of all three transistors Ts, Tp and TL are controlled by the modulator control circuit 14 based on the first control input (MOD) with the modulation sequence and the second control input (LO) which corresponds to the voltage V_{LED} across the LED.

The supply current I_{DC} is provided by a current source and supplied via the inductor L to the parallel connection of the supply switching transistor TL and the series connection of the serial transistor Ts and the LED with the parallel transistor Tp.

Thereby, a tri-state modulator is obtained with a first state (TL opened, Ts closed, Tp opened) during which the full current is fed through the LED, a second state (Tp closed) during which the LED is shunted for fast depletion, and a third state (Ts opened, Tp opened, TL closed) during which the LED is disconnected, but the DC current is allowed to pass via the inductor L through a closed bypass transistor TL.

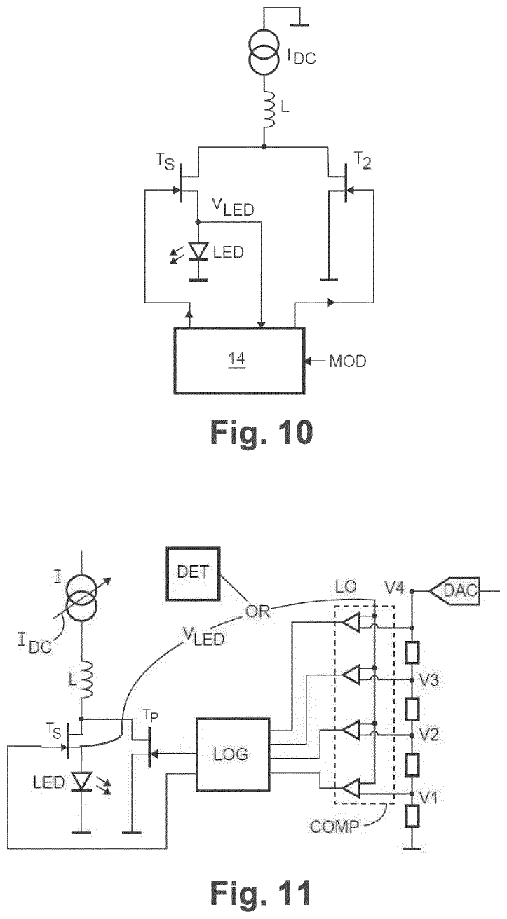

FIG. 10 shows schematically a circuit diagram of a light source driver according to a fourth embodiment.

In the fourth embodiment, the parallel transistor Tp of the third embodiment is removed and the supply switching transistor T2 (comparable to TL in FIG. 9) is still connected in parallel to the series connection of the serial transistor Ts and the LED.

The control terminals (e.g., gates) of the remaining two transistors Ts and T2 are controlled by the modulator control circuit 14 based on the first control input (MOD) with the modulation sequence and the second control input (LO) which corresponds to the voltage V_{LED} across the LED.

The supply current I_{DC} is provided by a current source and supplied via the inductor L to the parallel connection of the supply switching transistor T2 and the series connection of the serial transistor Ts and the LED.

Thereby, a tri-state modulator is still obtained with a first state (T2 opened, Ts closed) during which the full current is fed through the LED, a second state (T2 and Ts closed) during which the LED is shunted via Ts and T2 for fast depletion, and a third state (Ts opened, T2 closed) during which the LED is disconnected, but the DC current is allowed to pass via the inductor L through a closed bypass transistor T2.

FIG. 11 shows schematically an exemplary circuit diagram of a modulation control circuit according to a fifth embodiment, which can be used at least as a part of the modulation control 14 of the previous embodiments for controlling the parallel shunting transistor for depletion of the LED.

In the fifth embodiment, the modulation control circuit is configured for an OOK modulation between two binary levels, i.e., a first (higher) level (e.g., binary state “1”) defined around higher voltage levels V3 and V4, where the voltage range V4-V3 acts as a first hysteresis, and a second (lower) level (e.g., binary state “0”) defined around lower voltage levels V1 and V2, where the voltage range V2-V1 acts as a second hysteresis.

In the exemplary circuit of the fifth embodiment, a controllable DC current source I (e.g., an SMPS as described above) feeds the source current I_{DC} via an inductor L into an LED (transmitter light source) with a serial transistor Ts and a parallel transistor Tp. The inductor L serves to keep the source current stable and may allow for an optional additional storage capacitor across the output of the current source (not shown in FIG. 11).

The inductor L stores energy when the parallel transistor Tp short-circuits or bypasses the LED. The role of the inductor L can also be interpreted in a sense that when the parallel transistor Tp conducts, the current through the inductor L is built up, and when the parallel transistor Tp does not conduct, the higher voltage across the LED may reduce the current through the inductor L.

The inductor L may therefore by configured/designed to prevent, as it may unwanted oscillations caused by the combination with the internal capacitance of the LED. The current I_{DC} can be a fixed current determined at a system design stage and chosen such that the LED can be charged fast enough.

The control logic of the modulator control circuit may consist of a number of comparators (COMP) or gates configured to ensure high switching speeds of the LED by providing an output supplied to a control terminal (e.g., gate) of the parallel transistor Tp (e.g., a FET) and also an output supplied to the serial transistor Ts. The control logic is configured to translate measurements of the LED output (e.g., the voltage V_{LED} across the LED or an output of a detector (DET) for measuring a parameter (driving current, light output level, etc.) that indicates the light output) into the control outputs for the parallel transistor Tp and the serial transistor Ts.

The LED does not respond instantaneously to a current change and the voltage takes time to follow. This slowness in response is addressed by the proposed active control. Hence, the light output of the LED is the parameter that is intended to be controlled. However, an optical sensor increases complexity and/or may introduce additional latency or phase shift due to its junction capacitance or due to an additionally required transimpedance amplifier (TIA) and/or other electronics that introduce latency or phase shifts. Alternatively, the voltage V_{LED} across the LED pins can be used to monitor the light output. In fact, the voltage is an indicator of how far the junction (internal capacitance) of the LED is charged.

The modulation control circuit of FIG. 11 contains a control logic and an analog to digital conversion circuit (DAC) that translates the light output monitoring signal (i.e., second control input (LO) of FIG. 1) derived from the voltage VW across the LED or from the detector into a digital signal that indicates a specific level interval within the voltage levels V1 to V4, in which the level of the monitoring signal is actually located. The binary output state of each comparator switches to the other state if the level of the monitoring signal at one of its two inputs reaches a reference voltage level applied to the other input of the comparator.

The DAC receives a digital reference value and generates an analog reference voltage V4 that determines switching moments of the control output via a fixed or adjustable resistor network (voltage divider). More specifically, the resistor network divides the reference voltage V4 into respective lower voltages V3, V2 and V1 based on the ratios of the resistances of the resistor network. In the present example of a series connection of individual resistors, the voltage across one or more resistors corresponds to the reference voltage V4 multiplies by the ratio between the sum of resistance value(s) of the one or more resistors and the total resistance value of all serially connection resistors.

The different reference voltages V1 to V4 are applied to respective reference input terminals of the comparators.

The output voltage (reference voltage V4) of the DAC may be chosen to optimize the operation of the LED for the available current I_{DC} of the current source. To achieve this, the fraction of time that the parallel transistor Tp and/or the serial transistor Ts is switched on or off may be monitored and the reference voltage V4 may be increased if the parallel transistor Tp and/or the serial transistor Ts is switched on or respectively off too often, so that more current will reach the LED if the reference voltage V4 is higher.

The + and − inputs of the comparators are not shown, as they depend on the selected type of logic. If the polarities are flipped, the value of the input signal of the logic is swapped, which may simplify the circuits.

If the reference voltage V4 is controlled only and a fixed ratio is applied by the resistor network for the lower reference voltages V1 to V3, the control logic is less flexible for varying ranges. I.e., for longer ranges where lower bit rates are used, it may be tolerable that the LED takes more time to deplete further. Thereby, the distance between the reference levels can be increased. In an example, the lower voltage levels V1 and V2 can be set to a lower value.

In the example of FIG. 11, the reference voltage pairs V3/V4 and V1/V2 provide a hysteresis between which the light output of the LED can be maintained during the higher binary level (e.g., “1”) and the lower binary level (e.g., “0”), respectively.

However, an explicit hysteresis may not be needed and a mere signal level may be used with the simple rule:

If the conveyed symbol (binary state)=“1” and the monitoring signal (e.g., V_{LED}) is smaller than the highest reference voltage V4, then the parallel transistor Tp is switched off, otherwise (if the monitoring signal is larger than V4), the parallel transistor Tp is switched on to avoid overcharging of the LED.

Similarly, if the conveyed symbol (binary state)=“0” and the monitoring signal (e.g., V_{LED}) is smaller than the lowest reference voltage V1, then the parallel transistor Tp is switched off, otherwise (if the monitoring signal is larger than V4), the parallel transistor Tp is switched on to avoid overcharging of the LED.

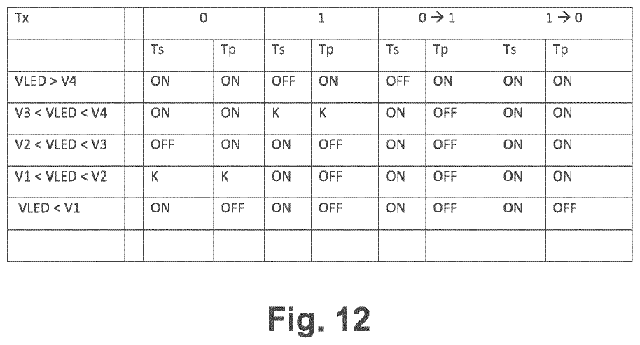

FIG. 12 shows a table of a modulation control scheme for a light source driver, e.g., with a modulation control circuit as shown in FIG. 11.

The modulation control scheme can be used for controlling a serial transistor Ts and a parallel shunt transistor Tp (as described in connection with the above embodiments) depending on a measured monitoring signal (e.g., V_{LED} which indicates the LED output level) with four reference voltage levels V1 to V4 during the transmission (Tx) of a lower binary state “0” or a higher binary state “1”, or during a transition from “0” to “1” or from “1” to “0”. A transition starts as soon as a new, different bit value arrives (e.g., a “0” after a “1”) and stops when the reference voltage reaches a predetermined value or range (e.g., <V1).

In the table of FIG. 12, the states “ON” and “OFF” indicate required switching states of the serial transistor Ts and the parallel shunt transistor Tp for a level of the monitoring signal indicated by the corresponding horizontal row and a transmitted information indicated in the respective vertical column. The state “K” (keep) indicates that the previous switching state is to be maintained (i.e., hysteresis loop).

In this example of FIG. 12, a hysteresis is applied and four intervals are defined as follows:

If V_{LED} is larger than V4, the LED is driven with an excessive current and may be damaged if the current is maintained and it may take too long to reach a level that will be detected as a logical “0” if a light output level above the value corresponding to V4 is allowed. Therefore, the parallel transistor Tp must be switched “on” to stop charging the LED further (for transmission of a logical “1” including both transition types). Furthermore, the serial transistor Ts, if implemented, can be opened during a logical “1” and a transition from “0” to “1”, since the LED can discharge itself via photon emission. During a transition from “1” to “0”, the serial transistor Ts can be closed to accelerate the discharge.

Between V4 and V3, Ts and Tp are both switched on when a transition from “1” to “0” is transmitted, or their level is maintained when a logical “1” is transmitted, or Ts is switched on and Tp is switched off when a transition from “0” to “1” is transmitted.

If the monitored light output (e.g., V_{LED}) drops below the reference voltage V3 and if the current transmission symbol is a logical “1” or a transition from “0” to “1”, then the light output is becoming too low. The receiver may thus detect an error (e.g., detect a “0” instead of a “1”). Therefore, the parallel transistor Tp must be opened in order not to discharge the LED further and Ts must be closed, to charge up the LED and to boost the light output level. Both Ts and Tp are switched on when a transition from “1” to “0” is transmitted, and Ts is switched off and Tp is switched on when a logical “0” is transmitted.

Below V1, the LED is depleted too far and thus becomes too slow and it may take too long to reach a level that will be detected as a logical “1” if the light output is allowed to fall below the value corresponding to V1. Therefore, Tp must be switched off (open) and Ts must be switched on (closed) to charge the LED, regardless of whether a transition from “0” or “1” is being transmitted.

If the monitored light output increases to a value that corresponds to a monitored value above V2 and if the current transmission symbol is a logical “0”, then the light output is getting too high. Therefore, the parallel transistor Tp must be switched on to discharge the LED and to decrease the light output. Particularly, if the symbol just went from a “1” to “0”, Ts is preferably closed (conducting) to accelerate discharge. When the transmitted symbol sequence is a prolonged logical “0”, and the monitored signal (VREF) can only slightly exceed V2, it may be considered to maintain Ts open (“K”) and Tp closed (“K”) and let the LED discharge via natural photon emission without acceleration.

It is noted that the combinations of logical value “0” at VLED>V3 and logical value “1” at VLED<V2 are non-realistic states that the system is not supposed to reach.

To summarize, a switched-mode light source driver with added functionality for accelerated modulation has been described, which is beneficial for e.g. fast OOK or PAM. An improved output stage includes a low-cost switched-mode power supply in combination with a shunt-switch and a series-switch arrangement, which are used in combination to provide a fast modulator. Thus, two switching functions are used in the output stage, one in series with the light source(s), one in parallel to the light source(s), wherein the light source(s) can be driven between a high and a low output level by using overdriving via a switch mode driver and shorting the output via the parallel switch.

While the invention has been illustrated and described in detail in the drawings and foregoing description, such illustration and description are to be considered illustrative or exemplary and not restrictive. The invention is not limited to the disclosed embodiments. The proposed accelerated keying concept can be applied to other types of optical wireless networks and with other types of access devices, modems and transceivers. In particular, the invention is not limited to LiFi-related environments, such as the ITU-T G.9961, ITU-T G.9960, and ITU-T G.9991 network environment. It can be used in visible light communication (VLC) systems, IR data transmission systems, G.vlc systems, OFDM-based systems, connected lighting systems, OWC systems, and smart lighting systems.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

The mere fact that certain measures are recited in mutually different dependent claims does not indicate that a combination of these measures cannot be used to advantage.

The described procedures like those indicated in FIGS. 2 and 3 can be implemented as program code means of a computer program and/or as dedicated hardware of the receiver devices or transceiver devices, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. A driver circuit for driving a semiconductor radiation source of an optical wireless communication transmitter in accordance with a digital modulation scheme for data communication comprising higher and lower states representing modulated data, the driver circuit comprising:
a switched mode power supply for generating an overdrive current supplied to the radiation source, the overdrive current being higher than a steady-state current required for a desired radiation output level for a corresponding state of the digital modulation scheme;
a modulator comprising a first switching element connected in series to the radiation source and a second switching element connected in parallel to the series connection of the first switching element and the radiation source; and
a control circuit for controlling the switching states of the first and second switching elements to maintain a radiation output of the radiation source within a target output range for proper detection of the higher and lower states when received at an optical wireless communication receiver and for closing the second switching element to bypass the overdrive current during an open state of the first switching element.

2. The driver circuit of claim 1, wherein the switched mode power supply is configured as a current source with an inductor element and no capacitor element at an output thereof.

3. The driver circuit of claim 1, wherein the control circuit is configured to adaptively control the switching states of the first and second switching elements to switch the overdrive current at a timing determined by the target output range between a predetermined upper target level and a predetermined lower target level in response to a control input that indicates the radiation output.

4. The driver circuit of claim 3, wherein the control circuit is configured to compare the control input with a lower reversal limit and an upper reversal limit and to switch off the overdrive current when the control input has reached the upper reversal limit and/or to switch on the overdrive current when the control input has reached the lower reversal limit.

5. The driver circuit of claim 3, wherein the control circuit is configured to maintain the predetermined upper target level and the predetermined lower target level by switching the overdrive current at a higher rate than a symbol rate of a data sequence of the digital modulation scheme.

6. The driver circuit of claim 1, wherein proper detection of the higher and lower states is quantified by a transmission quality and the transmission quality of the radiation output is determined based on a feedback information received from a receiving end of the radiation output.

7. The driver circuit of claim 1, further configured to provide a control input for setting at least one of a bit rate or duty cycle for the overdrive current, and an allowable maximum and/or minimum output radiation level or output radiation range for the radiation source.

8. The driver circuit of claim 1, wherein the switched mode power supply comprises an inductor to bridge fluctuations of the overdrive current supplied to the radiation source.

9. The driver circuit of claim 1, further comprising an active control loop with a sensing element to stabilize the overdrive current in the presence of long-term load variations.

10. The driver circuit of claim 1, wherein the control circuit is configured to operate the modulator as a tristate modulator with a first state of charging up an internal capacitance of the radiation source, a second state of depleting the internal capacitance of the radiation source, and a third state of holding the charge of the internal capacitance of the radiation source.

11. The driver circuit of claim 10, wherein the control circuit is configured to use level pairs of a plurality of reference voltage levels to provide a hysteresis between which the radiation output of the radiation source can be maintained during the higher and the lower state, respectively.

12. The driver circuit of claim 1, wherein the digital modulation scheme is an on-off keying scheme or a pulse amplitude modulation scheme.

13. A transmitter for generating a radiation signal in an optical communication system, wherein the transmitter comprises an apparatus as claimed in claim 1.

14. A method of driving a semiconductor radiation source of an optical wireless communication transmitter in accordance with a digital modulation scheme for data communication comprising higher and lower states representing modulated data, the method comprising:
supplying an overdrive current to the radiation source, the overdrive current being higher than a steady-state current required for a desired radiation output level for a corresponding state of the digital modulation scheme;
controlling the switching states of a first switching element connected in series to the radiation source and of a second switching element connected in parallel to the series connection of the first switching element and the radiation source to maintain a radiation output of the radiation source within a target output range for proper detection of the higher and lower states when received at an optical wireless communication receiver; and
closing the second switching element to bypass the overdrive current during an open state of the first switching element.

15. A non-transitory computer readable medium comprising instructions, the instructions when executed by a processor of a control device cause the control device to perform the method of claim 14.
